(19) United States
(12) Patent Application Publication
(10) Pub. No.: US 2009/0037315 A1
(43) Pub. Date: Feb. 5, 2009

(54) System and method for brokering agents and auditionees

(76) Inventor: William Chu, Vienna, VA (US)

Correspondence Address: HARNESS, DICKEY & PIERCE, P.L.C., P.O. BOX 8910, RESTON, VA, 20195, US

(21) Appl. No.: 11/716,723

(22) Filed: Aug. 3, 2007

(51) Int. Cl. G06Q 99/00; G06F 17/30; G06F 17/40; G06Q 40/00

(52) U.S. Cl. 705/37; 705/1

(57) ABSTRACT

Example embodiments relate to methods and systems for ranking a content submitted by an auditionee. The method may further include retrieving the content stored in a talent broker management system by a user, reviewing the submitted content, rating the content based on a ranking score, recording an IP address of the user, recording the submitted ranked content, and determining whether the user is a duplicate user that rates the same submitted content, wherein when the user is determined a duplicate, the system may reduce the ranking score of the duplicate user. The method may also allow auditionees to bid their submitted video to be displayed for a particular time slot.

### BACKGROUND

1. Field of the Invention

Example embodiments relate generally to the recognition and distribution of artistic contents, more specifically, utilizing an Internet web application to serve as a broker between agents and auditionees.

2. Description of Related Art

One of the challenges facing new independent artists is promoting and distributing their artistic works to the public. Although not necessarily needed, a talent agent may help an artist to be recognized by the art industry. A talent agent may facilitate the arrangement of an exclusive recording contract, arrange performances for the artist, and may also obtain and negotiate contracts of employment in other areas of entertainment on the artist's behalf. Methods such as submitting the artists' work (e.g., tapes, videos, music, photographs, movie or television scripts, and any other literary compilations) directly to the talent agents have typically been used, but this approach generally cannot reach the vast pool of agents available to the artist.

Recently, the Internet has created a medium for artists to promote their works. For instance, the artist may promote and distribute their work via Internet by providing a forum to present and/or sell their artist work. One such forum has been to create a website where the artist can communicate with a talent agent. The artist generally uploads the creative work in electronic format and submits the creative work to an internet web application which serves as a broker between the talent agent and artist. In addition, the artist may agree to have his or her work to be reviewed by the talent agent, other artists and/or the general public so as to receive feedback based on a rating. However, most Internet web applications generally allow the public to vote and comment on the artists' work that has been downloaded without setting forth any limitation. That is, the rating of the artist may not be accurate because the rating system may be circumvented to skew an accurate representation. For example, the artist may have friends or even themselves ‘stuff’ the ballots by repeatedly voting for the same artist.

Accordingly, there exists a need for an Internet web application that provides a rating system which accurately rates the artist by weighting the sources of the votes.

### SUMMARY

Example embodiments relate to methods and systems for ranking a content submitted by an auditionee. The method may further include retrieving the content stored in a talent broker management system by a user, reviewing the submitted content, rating the content based on a ranking score, recording an IP address of the user, recording the submitted ranked content, and determining whether the user is a duplicate user that rates the same submitted content, wherein when the user is determined a duplicate, the system may reduce the ranking score of the duplicate user.

In a further example embodiment, the method may retain the IP address of the user.

In yet a further example embodiment, the IP address may be retained for a pre-determined time.

In yet a further example embodiment, the IP address may be discarded after a pre-determined time.

In an example embodiment, the system rejects the ranking score of the duplicate user when the user is determined a duplicate.

In an example embodiment, the method may further accept the IP address, and record the submitted ranked content.

In a further example embodiment, the system may accept and record more than one user having different IP addresses.

In yet a further example embodiment, the users may be at least one of an agent and public user.

In a further example embodiment, a ranking score from the agent may be given greater weight than a ranking score from the public user.

In a further example embodiment, a ranking score from an initial public user may be given greater weight than a subsequent same public user.

Example embodiment may be related to a system for ranking a content submitted by an auditionee. The system may include a talent broker management system for serving as the broker between an user and the auditionee. The talent broker management system may include a server and a computer-readable storage. The talent broker management system may be configured to execute the instructions of retrieving the content stored in a talent broker management system by a user, reviewing the submitted content, rating the content based on a ranking score, recording an IP address of the user, and determining whether the user is a duplicate user that rates the same submitted content.

Example embodiments may relate to a method for bidding on a time slot for an artistic content submitted by an auditionee. The method may include selecting a particular time slot for the artistic content to be reviewed, and bidding on the particular time slot by setting an amount for the selected time slot.

In a further example embodiment, the system may include a bidding structure to allow auditionees to bid for a video display time slot. This may provide auditionees a way to make their video more visible to the agents and the public if the auditionee wins a bid for displaying their videos.

In yet a further example embodiment, the auditionee may submit one of the video as a bid for a time slot and if the auditionees has the highest bid for that time slot, that auditionee's video will be guaranteed to be shown at a reserved location on the main page.

### BRIEF DESCRIPTION OF THE DRAWINGS

Exemplary embodiments of the present invention will become more apparent by describing, in detail, exemplary embodiments thereof with reference to the attached drawings, wherein like procedures are represented by like reference numerals, which are given by way of illustration only and thus do not limit the present invention.

FIG. 1 is a block diagram of a method for utilizing an Internet web application to serve as the broker between agents and auditionees.

FIG. 2 is a flowchart illustrating an exemplary auditionee profile page for submitting profile of the artist.

FIG. 3 is a flowchart illustrating an exemplary agent profile page for submitting profile of the agent.

FIG. 4 is a display screen view of an exemplary main web page.

FIG. 5 is a display screen view of an exemplary auditionee profile page.

FIG. 6 is a display screen view of an exemplary agent profile page.

FIG. 7 is a display screen view of an exemplary web page for ranking the artistic content.

FIG. 8 is a display screen view of an exemplary agent tools profile page for agents to search, sort and categorize auditionees searching tool.

FIG. 9 is a sequence flowchart illustrating an exemplary smart rating system.

FIG. 10 is a display screen view of an exemplary final web page for submitting the artistic content.

FIG. 11 is a display screen view of an exemplary auditionee page for bidding on a particular time slot.

### DETAILED DESCRIPTION OF EXEMPLARY EMBODIMENTS

It should be noted that these Figures are intended to illustrate the general characteristics of method and apparatus of exemplary embodiments of this invention, for the purpose of the description of such exemplary embodiments herein. These drawings may not precisely reflect the characteristics and/or operation of any given embodiment, and should not be interpreted as defining or limiting the characteristics and/or operation of exemplary embodiments within the scope of this invention. Like numerals are used for liked and corresponding system of the various drawings.

The term “auditionee” as used herein may refer to an artist (e.g., musicians, models, authors, screenwriters, photographers, painters, etc.) who may submit his or her artistic work.

The term “agent” as used herein may refer to an independent agent, talent agencies, studios and/or other buyers.

The term “artistic content” as used herein may refer to an artists' work, such as, but not limited to, music, photos, books, appearances, tapes, videos, movie or television scripts, paintings, and any other literary compilations, which may be reviewed and ranked by the agent.

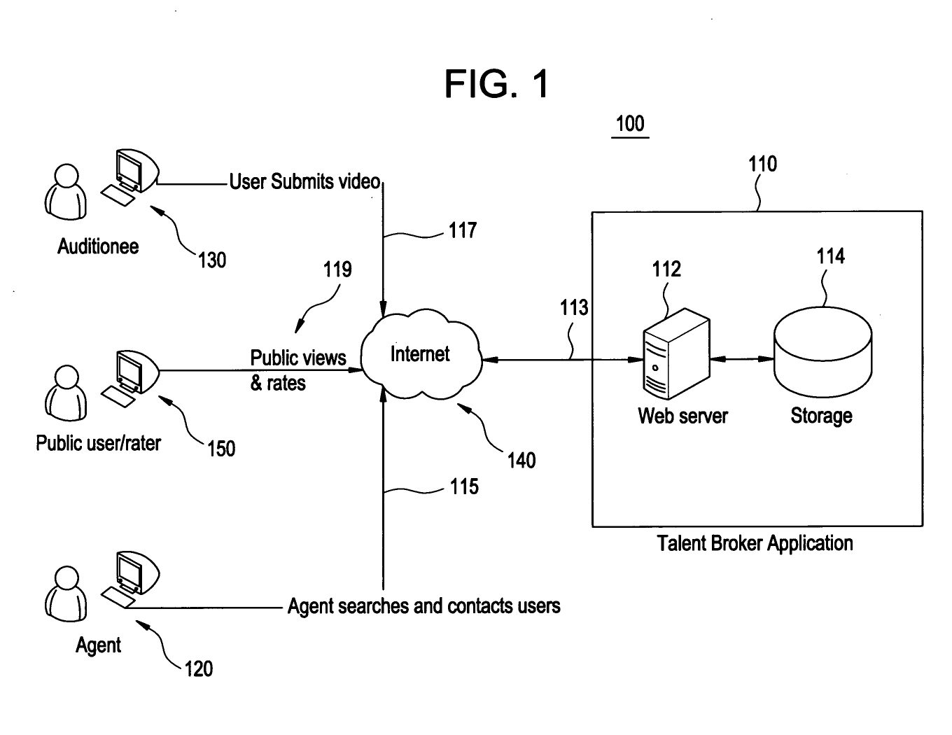

FIG. 1 is a block diagram of an Internet web application system 100 according to an example embodiment. The system 100 may include a talent broker management system 110 for serving as the broker between an agent 120 and an auditionee 130. The talent broker management system 110 may include a server 112 and a computer-readable storage 114. The server 112 may operate one or more web pages of the network, (e.g., the Internet or World Wide Web). The computer-readable storage 114 can be utilized as a database, for example, but not limited to, storing artistic contents, storing contents submitted by the auditionee, agent and/or public, storing feedbacks, and storing links to other locations where the content may be stored, such as a memory of the agents' access device (e.g., PC, PDA, cellular phones, etc.)

It should be appreciated that the system 100 may be operated in other networks, such as local area network (LAN) and/or wide area network (WAN).

The talent broker management system 110 may be coupled to a communication network 140 (e.g., Internet or World Wide Web) via interface 113, which interconnects the agent 120 via interface 115, auditionee 130 via interface 117, and the public user 150 via interface 119. It should be appreciated that the communication network 140 and the interfaces 113, 115, 117, 119 coupled thereto may operate according to any know communication technology such as wired networks (e.g., POTS and etc.) or wireless networks (CDMA, TDMA, GSM and etc.).

It should further be appreciated that other entities, such as, but not limited to, artist peers, talent agencies, studios and recording companies, may interface and communicate with the talent broker management system 110.

The talent broker management system 110 may receive the auditionee's artistic content from the artist in electronic format (e.g., .mpeg, .avi, .mov., pdf, .jpg and etc.) and stored in the computer-readable storage 114. In an example embodiment, the required format operations of operating a video may be, for example, QuickTime, Windows Media, MPEG, DV or 3GPP.

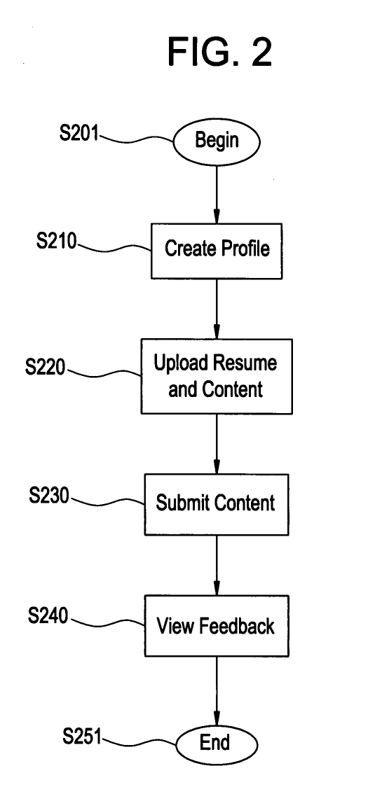

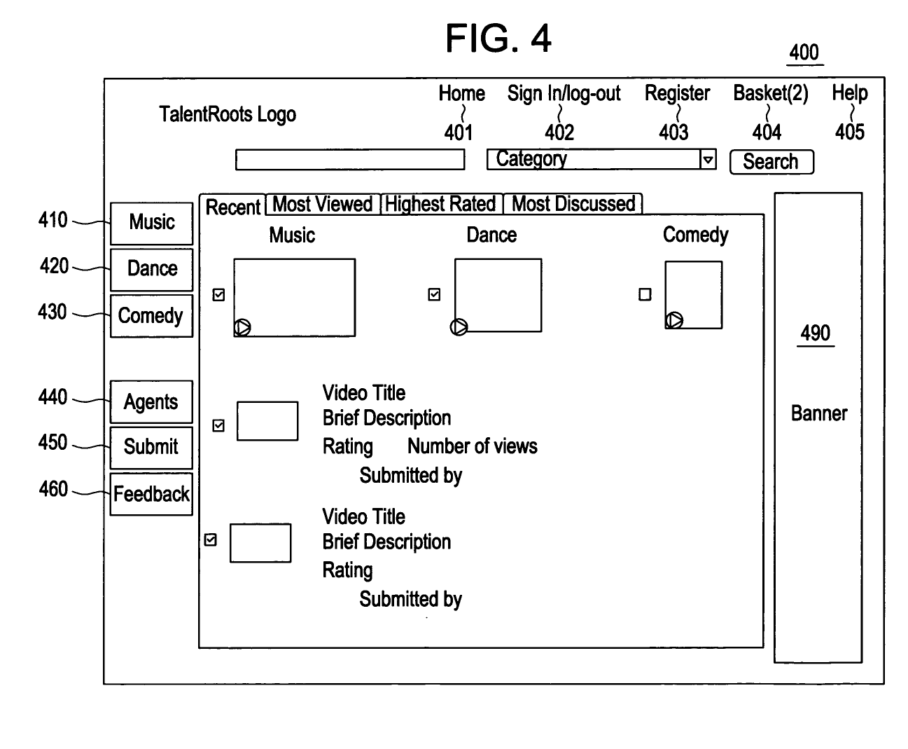

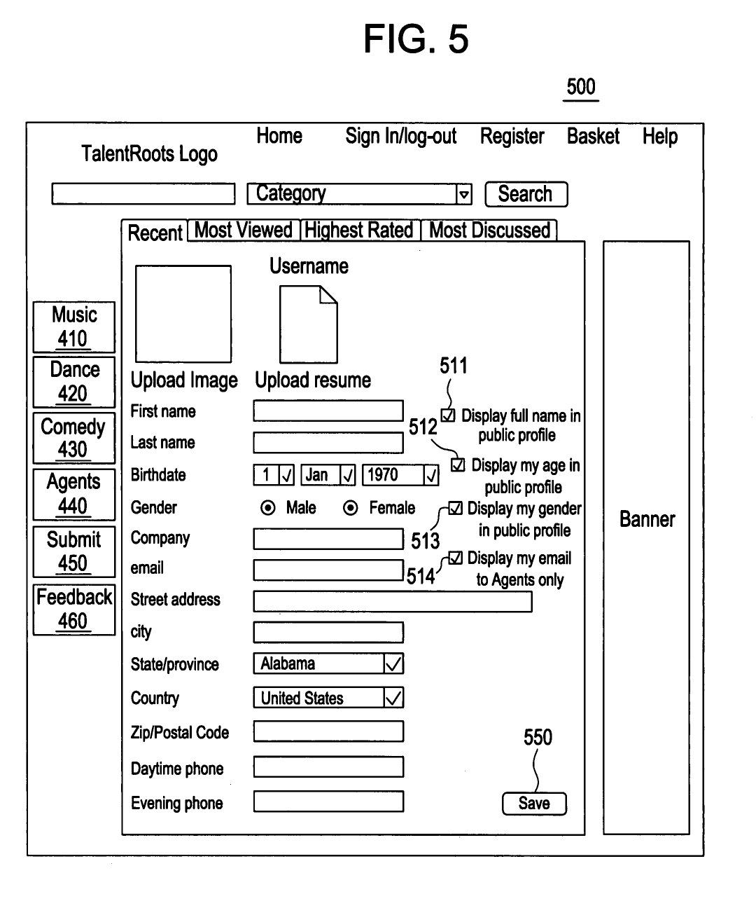

FIG. 2 depicts a flowchart of a method 200 operating by the talent broker management system 110 in accordance to an example embodiment. The method 200 may begin at S201 where the auditionee logs into the talent broker management system 110. For example, the auditionee may go to the main web page 400 and click on a “Register” icon 403 (shown in FIG. 4) to enter the auditionee's profile while at the same time create a password so that only the rightful owner of the artistic content may have access to the file. At this time, the auditionee may then create a profile (S210) of himself or herself. The profile created by the auditionee may be the auditionee's name, auditionee's address, auditionee's birth, auditionee's gender, company, auditionee's email address and phone numbers (as shown in FIG. 5). It should be appreciated that other information may be added or deleted depending on the desired information sought. After the creation of the profile, the auditionee may then upload his resume and the artistic content (S220). It should be appreciated that the artistic content may be in one of the desired formats (e.g., .mpeg,-.avi, .mov, .pdf, .jpg, etc.). Next, the auditionee submits the artistic content to be transmitted via Internet (S230), and stored in the talent broker application system 110 until retrieved by an agent 120 and/or a public user 150. Once the content has been submitted, the auditionee may view feedbacks by viewing the public's rating and comments of the content in the auditionee's account. It should be appreciated that other means of retrieving the feedback may be achieved, for example, but not limited to, the artist may receive an email or an internal messaging system that a feedback is saved in the talent broker management system 110. The email or message may be received by any computing device, such as, but not limited to, a personal desktop computer, a laptop, a cellular phone, a PDA, or other electronic devices.

It should be appreciated that all information relating to the auditionee and the artistic content may be stored on the talent broker application system 110 until ready to be retrieved.

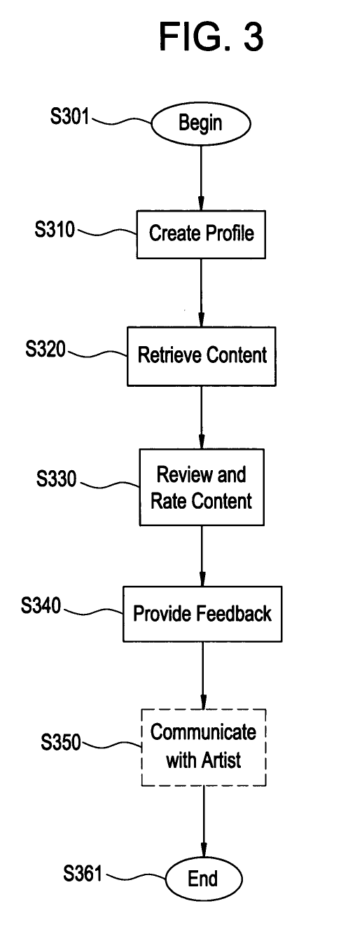

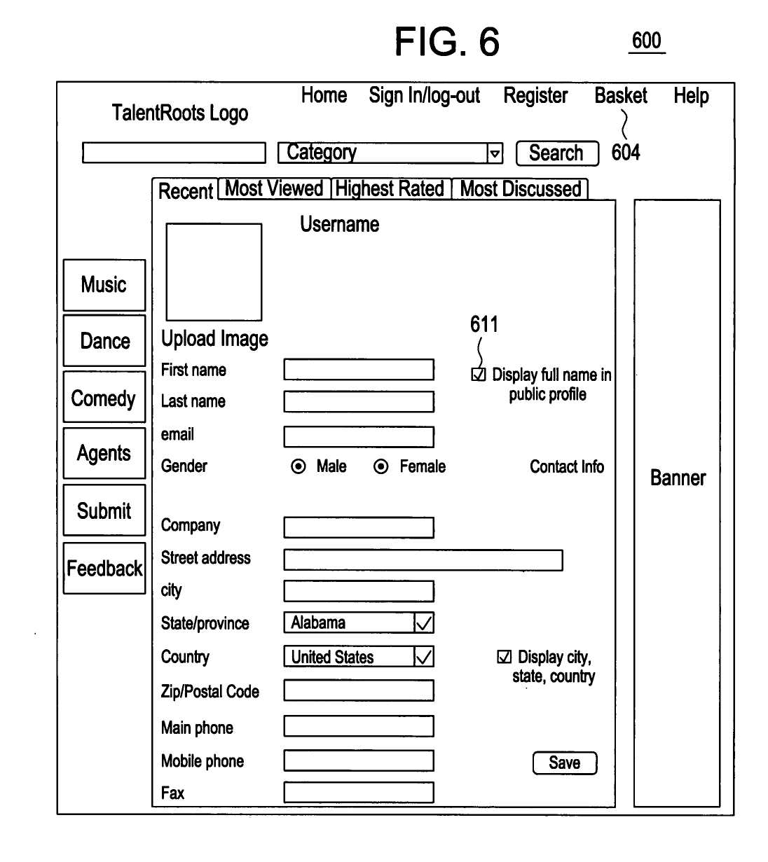

FIG. 3 depicts a flowchart of a method 300 in operation of the talent broker management system 110 in accordance to an example embodiment. The method 300 may begin at S301 where the agent creates a profile (S310), and creates a password so that only the rightful agent may retrieve and review the artistic content. The profile created by the agent may be the agent's name, agent's address, company representation, agent's email address and phone numbers (as shown in FIG. 6). It should be appreciated that other information may be added or deleted depending on the desired information sought. Once the agent creates the profile, the agent may request to retrieve the artistic content (S320) from the talent broker application system 110 and commence reviewing the content. As shown in FIG. 4, the main web page 400 may contain a “basket” icon 404 (e.g., ‘in-basket’) to notify the agent that there are a plurality of contents to be reviewed. At S330, the agent may review the artistic content from the auditionee(s) and may rank (e.g., on a scale of bad to awesome) the content based on other pre-screened contents. As will be discussed later, the ranking score from the agent will have a heavier weight as compared to the public's ranking score. If desired, the agent may provide feedback (S340) back to the auditionee based on the reviewed content. The agent may also communicate directly with the auditionee (S350) to possibly form a partnership between the auditionee and the agent.

FIG. 4 is a display screen view of an exemplary main web page 400. Referring to FIG. 4, the main web page 400 may include an icon for home 501, sign in/logout 402, register 403, basket 404, and help 405. As discussed above, the auditionee should register and create a profile with the system so that the agent may search and review the submitted content.

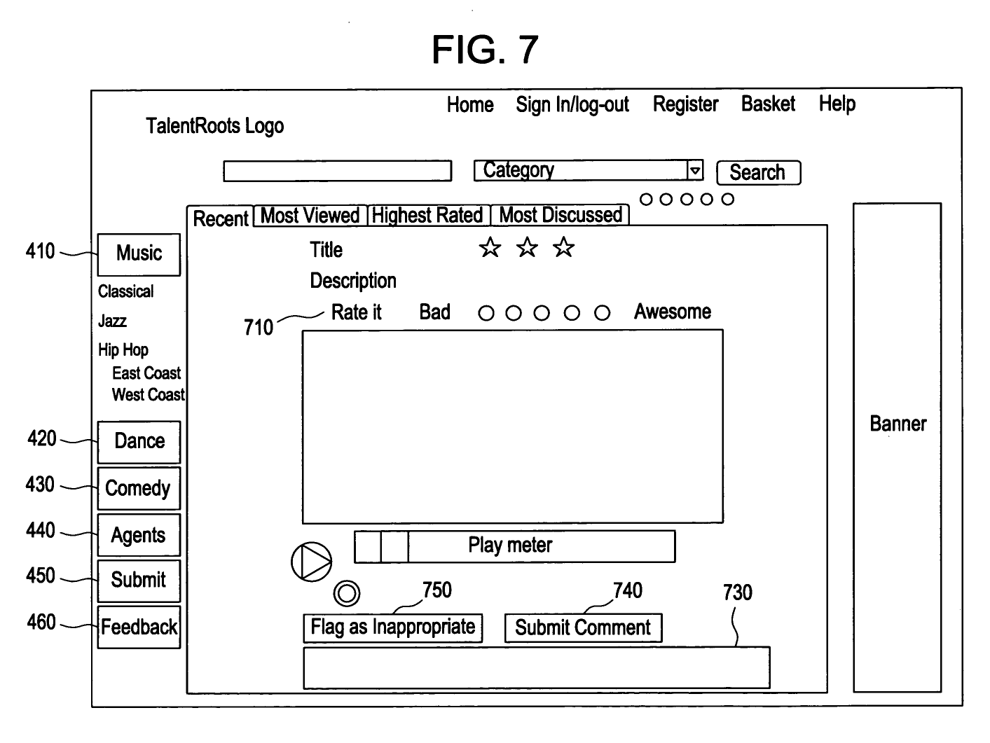

The main web page 400 may further include ‘content’ icons (e.g., music 410, dance 420, comedy 430) an ‘agent’ icon 440 for only agents' access, a ‘submit’ icon 450 for submitting the content, and a ‘feedback’ icon 460 for providing feedback to the website. It should be appreciated that other icons may be implemented. Each of the content icons 410, 420, 430 may also contain sub-categories to break down the type of content. For purposes of illustration, the music icon 410 may contain different type of music categories, such as, classical, jazz, hip hip, rock, etc. (as shown in FIG. 7) for the auditionee to specifically upload the content.

The main web page 400 may further include an area 490 in the main web page 400 for displaying banners, such as advertisements, announcements, etc.

FIG. 5 is a display screen view of an exemplary auditionee profile page 500. Referring to FIG. 5, the auditionee profile page 500 may include information, such as, auditionee's first name, last name, birthday, gender, company, email, street address, city, state/province, country, zip/postal code, daytime phone, and evening phone. It should be appreciated that the above list is not exclusive and other information may be added to the auditionee profile page 500. During the auditionee profile page 500, the auditionee may have the additional feature to check the option to display full name in public profile 511, display age in the public profile 512, display gender in the public profile 513 and display email to agents only 514. If none of the above options are clicked, the system will by default not display any of the above functions in the talent broker management system 110. Once all the appropriate information is entered, the auditionee then uploads the resume and content. The auditionee then clicks the “save” button 550 on the auditionee profile page 500 so as to save the content. Moreover, because the auditionee profile page 500 is registered and saved, the auditionee may edit the content at a later time. Once all appropriate information and content to be uploaded are properly entered and uploaded, the auditionee clicks the submit button 450 so that the contents are stored in the talent broker management system 110 in which eventually an agent will review and rank the content.

The auditionee profile web page 500 may further include a link (not shown) to a message inbox so that the auditionee may retrieve comments from the agents. The auditionee profile web page 500 may also include a link (not shown) to attached videos which have comments from public users. For example, the auditionee_profile page 500 has a link to Get My Messages which is a link to an email inbox. The Get My Messages is a link to the auditionee's mail inbox but only contains messages from agents. Moreover, agents can send email messages to an auditionee through a send message link that is displayed only for agent logins.

FIG. 6 is a display screen view of an exemplary agent profile page. Referring to FIG. 6, the agent profile page 600 may include such information as agent's first name, last name, email, gender, company, street address, city, state/province, country, zip/postal code, main phone, mobile phone and facsimile. It should be appreciated that the above list is not exclusive and other information may be added to the agent profile page 600. The agent may have the option to display or not display his or her full name in the public profile 611. As similarly discussed above with regard to the auditionees' profile page, the agent must also register to gain access to the artistic contents stored in the talent broker management system 110. Upon completion of registration, the agent then saves his or her information and creates a password so as to retrieve the artistic contents.

In order to review and rank the various artistic contents, the agent selects the particular type of content, e.g., music 410, dance 420 or comedy 430, to be reviewed and downloads the content to his or her computing device. It should be appreciated that the computing device should include software to operate and run the downloaded content.

The agent profile page 600 also enables the agent to place the contents into a queue to be reviewed at a later time. As an example embodiment, the agent profile page 600 may include a basket icon 604 to indicate how many contents the agent needs to review.

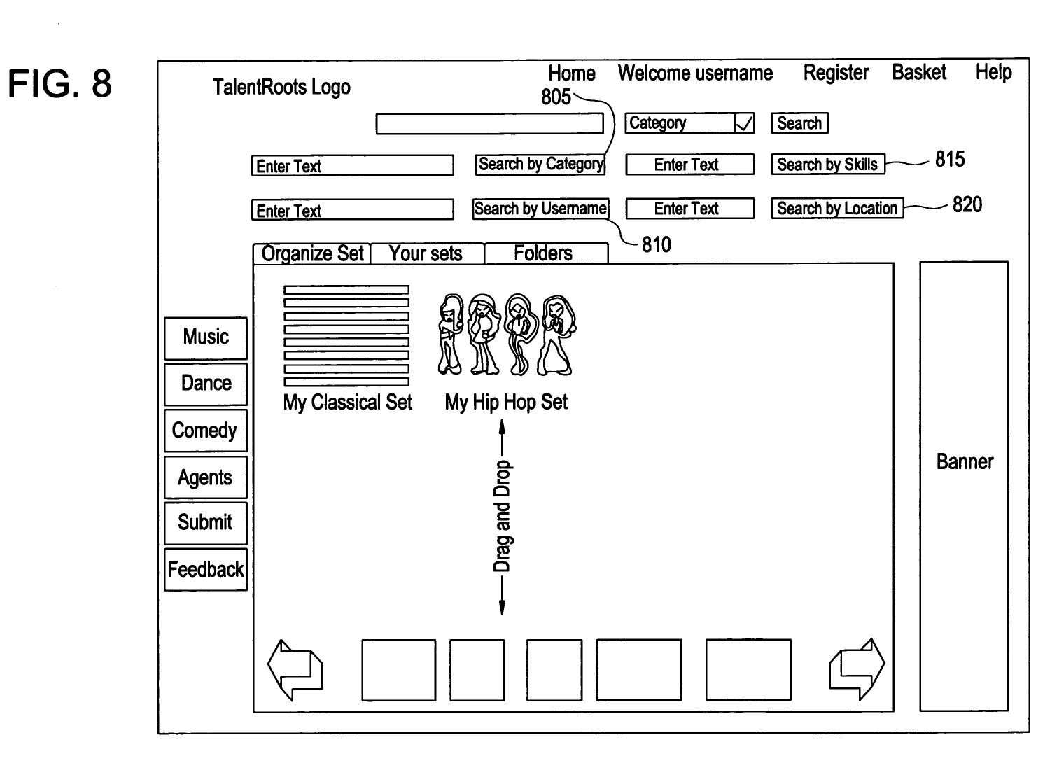

Referring to FIG. 8, the agent may have tools to search a particular auditionee by category 805, username 810, skill 815 and/or location 820 by a search tool page 800. The search tool page 800 may also perform a search by sorting and categorizing the auditionee. Categories may be user defined by the agents. In other words, the agent may create categories to organize his/her potential clients. For example, the agent can create categories such as HipHop_January, HipHop_February, SoulDance_temp and etc. Accordingly, the agent may organize his/her categories to be desired.

It should be appreciated that the search tool page may also store and file potential auditionees in a “cabinet” page. The cabinet page may be similar to an office cabinet that files the potential candidates (e.g., a cabinet page may be a metaphoric storage for the collection of categories).

Once the content is downloaded, the agent may review the content and may provide feedback(s) to the auditionee. An example embodiment of a feedback may be employing a rating system.

Referring to FIG. 7, a rating web page 700 for ranking the artistic content is shown. The rating web page 700 may include a rating system 710 for ranking the content from “bad” to “awesome”. It should be appreciated that other rating system may be employed, such as using numerical values. Although the example embodiment displayed only five ranking positions, it should also be appreciated that more or less ranking positions may be employed.

The agent may also provide feedback by submitting comments in area 730. The comments may be written, oral and/or video review of the content reviewed. Once the agent concludes rating the content, the agent clicks button 740 to submit the reviewed content to be stored in the talent broker management system 110.

The rating web page 700 may also include a button 750 for indicating that the content is inappropriate. This will notify the public that the content may be inappropriate for some viewers.

Referring back to FIG. 1, the talent broker management system 110 may also receive reviews and rankings from the public 150. The public user 150 may go to the web page linked to the talent broker management system 110 and commence reviewing the artistic contents of a particular artist. In order to prevent multiple reviews from the same user, the public user must log in (with a created password) so as to keep track of IP address associated with the user name. As similar discussed above with regard to the agent, the public user may choose the type of artist content (e.g., music 410, dance 420, comedy 430) he or she wants to review by clicking on the appropriate icons, and selecting a sub-category, if required. Once the particular artistic is chosen, and reviewed, the public user may rate the content by clicking on one of the “rate it” 710 options, e.g., “bad to awesome”. The ranking is then transmitted to the talent broker management system 110 to be processed and stored.

As an alternative embodiment, the public user may also provide comments 530 to be reviewed by the auditionee. The comments section 730 (as shown in FIG. 7) may be used to provide specific feedback of the content reviewed. It should be appreciated that the feedback may be written, oral and/or video review of the content reviewed.

As discussed above, the conventional art fails to prevent and/or reduce the public from ‘stuffing’ the ballots when ranking the auditionee (e.g., the auditionee may ‘stuff’ the ballots by repeatedly voting for the same auditionee).

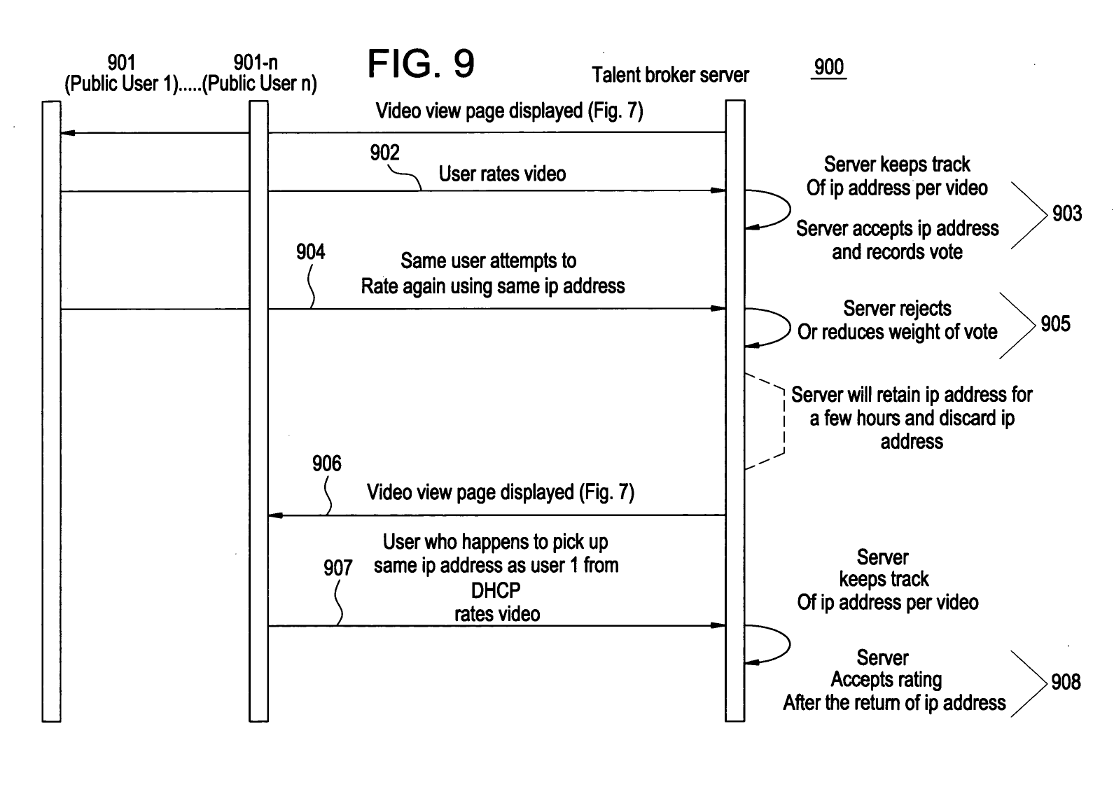

FIG. 9 is a sequence flowchart illustrating an exemplary smart rating system 900. Referring to FIG. 9, a smart rating system 900 is employed to prevent public users 901 . . . 901n from ‘stuffing’ the ballot. The term ‘stuffing’ may mean the prevention and/or reduction of duplicate votes. The public user request a video view page to be displayed from the system 900, and rates the video 902. The rated video is then submitted to be recorded and stored by the system. The system 900 may keep tracks of the time and IP address of the originator of the vote per content 903, and accepts the IP address and records the vote 903. If the same user attempts to vote again using the same IP address 904, the server will either reject the vote or severely reduce the weight of that vote 905. This may prevent public users from voting many times for the same content thereby reduce ‘stuffing’ of the ballot. It is understood that the majority of IP address for public users may be DHCP (Dynamic Host Configuration Protocol) which means public users receive new IP addresses from their local internet provider when they reboot their computer system. So a public user may disguise him/herself as a new user by rebooting the user's computer system. To minimize the rebooting situation, the system 900 for each vote may determine the subdomain where the vote came from and will give less weight for each vote originating from the same subdomain within a time interval (e.g., generally 1-2 hours). Also to minimize the above situation, each vote will require a token from a cookie that has been placed on the user's machine to track the machine has voted before. Although the user may delete cookies to disguise him/herself, attempting to disguise themselves as a new user is time consuming which will discourage ballot stuffing. It is also understand that once the public user reboots his/her original IP address may be re-used by another public user. So the IP address per video will be refreshed so that other user who happens to pick up the same IP address as the original user for that video may be able to vote at a later time.

Other public users 901-n may rate the video 907. However, in some instances, the public user 901-n may pick up the same IP address as initial public user 901 when the public user 901 has logged off and returned the IP address back to the DHCP pool. In this case, the server may keep track of the IP address per video. Because the same IP address is stored and recorded, the rating system 900 will not accept the rating until the IP address is returned back to the DHCP pool 908. The rating system 900 may refresh an IP address so that other users may use that same IP address to rate a video.

Further, the system 900 may place greater emphasis (higher weight) on the ranking of agents or public users based on how long the agent/public user has been registered, prior success in the industry, memberships, and other qualifications. Moreover, the system 900 may place higher weight on agents/public users who have paid money. It has generally been found that paid users have higher credibility.

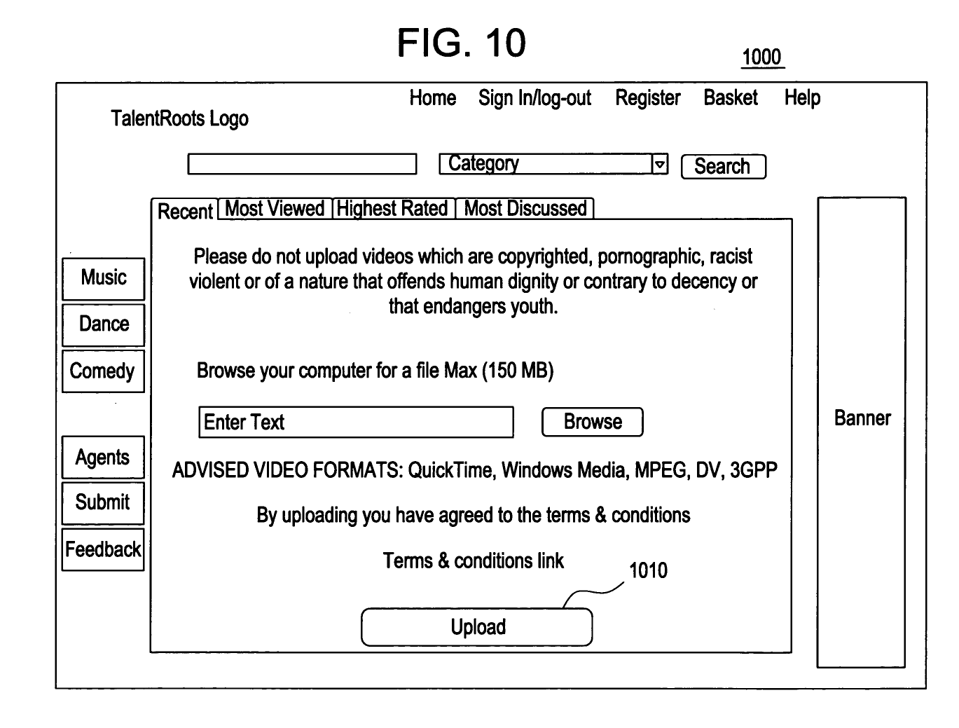

FIG. 10 is a display screen view of an exemplary final web page 1000 for submitting the artistic content. During the final checkout, the talent broker application system 110 may request the auditionees, agents, and public users to require agreeing to terms of use policy and/or legal disclaimer before submitting and receiving the artist contents. In an example embodiment, the user may be required to agree to terms of regarding artists' intellectual property rights, prohibiting the use of pornographic, racist, violent or a nature that offends human dignity or contrary to decency or that endangers youth. It should be appreciated that other terms and conditions may be attached. Once all terms and conditions are to satisfaction, the user clicks on the “upload” button 1010 and the artistic content is then uploaded to the talent broker application system 110 to be reviewed and ranked.

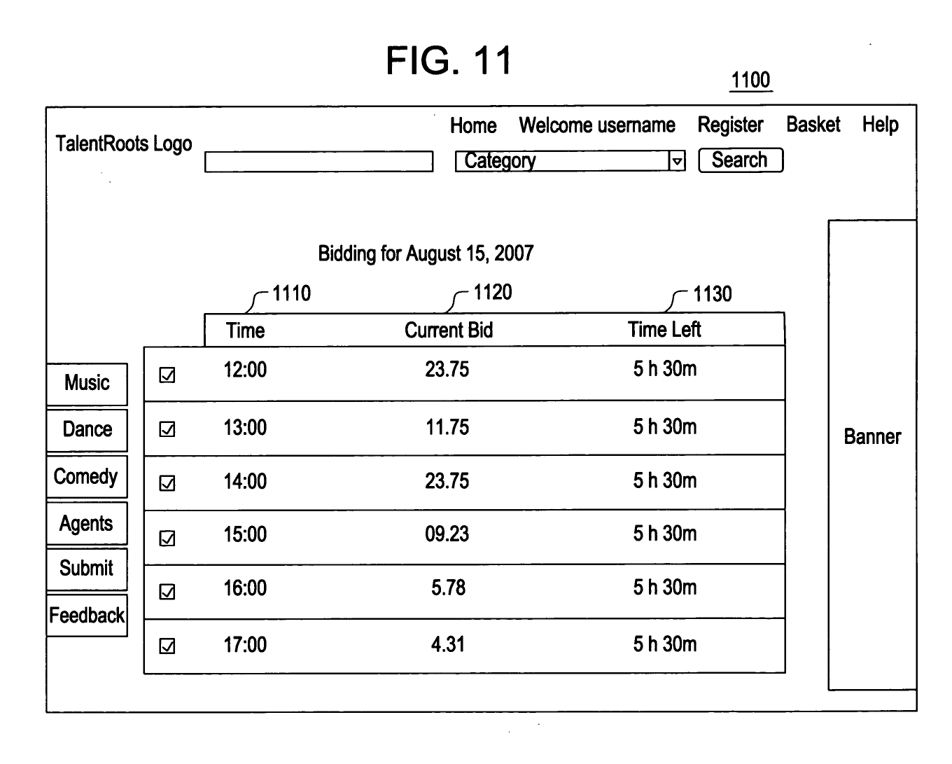

FIG. 11 is a display screen view of an exemplary auditionee page for bidding on a particular time slot. As shown in FIG. 10, the web page 1100 provides the auditionee to bid on a particular time-slot so as to ensure that the artistic content may be seen during primetime by the agent. Time slots generally in the evenings may provide a greater chance that the agent will at least review and rank the artistic content submitted by the auditionee. For the public user, the best time slots may be weekdays between the period of 8 pm EST to 2 am EST. For example, as depicted in conventional on-line auction, web page 1100 may also include options for “time” 1110, “current bid” 1120 and “time left” 1130. The auditionee may select a particular time 1010 he or she desires, and bid on an appropriate price 1120 he or she is willing to pay. As in most bidding system, if the auditionee's original bid is lower than the then next lowest bid, the auditionee will have the opportunity to place a higher bid as long as the time to place the bid has not expired. Option 1130 indicates the amount of time available before the auditionee has an opportunity to bid on the time option. Once the time elapses, the auditionee (or any one else) will not be able to bid on that particular time.

As an example embodiment, auditionees may enter their maximum bid amount up to a capped maximum amount. The capped maximum amount may prevent auditionees from overspending on a time slot and prevent ludicrous bids. Each auditionee may enter in their maximum bid amount. The auditionee that has entered the highest maximum bid amount at the closing of time slot auction may be guaranteed to have their video displayed for the winning time slot. Their content may be displayed in a location designated for the winning bid. The winning bid amount may not be necessarily the maximum bid amount (e.g., it depends on the next highest maximum bid amount). For example, if Auditionee 1 has a maximum bid amount of $50.00 and the current bid amount at closing of the auction is $30.00, then the auditionee will only pay $30.00 if there are no other bids. If however, Auditionee 2 submits a maximum bid amount of $40.00 prior to auction closing, then the current bid amount prior to closing will increase to $40.01 because Auditionee 2 did not exceed the highest maximum bid amount but increased the current bid amount to his/her maximum amount plus one cents.

The exemplary embodiments of the present invention being thus described, it will be obvious that the same may be varied in many ways. Such variations are not to be regarded as departure from the spirit and scope of the exemplary embodiments of the present invention, and all such modifications as would be obvious to one skilled in the art are intended to be included within the scope of the following claims.

What is claimed:

1. A method for ranking an artistic content submitted by an auditionee, comprising:
retrieving the artistic content stored in a talent broker management system by a user;
reviewing the submitted artistic content;
rating the artistic content based on a ranking score;
recording an IP address of the user; and
determining whether the user is a duplicate user that rates the same submitted artistic content,
wherein when the user is determined a duplicate, the system reduces the ranking score of the duplicate user.

2. The method according to claim 1, further comprising retaining the IP address of the user.

3. The method according to claim 2, wherein the IP address is retained for a pre-determined time.

4. The method according to claim 2, wherein the IP address is discarded after a pre-determined time.

5. The method according to claim 1, wherein when the user is determined a duplicate, the system rejects the ranking score of the duplicate user.

6. The method according to claim 1, further comprising:
accepting the IP address; and
recording the submitted ranked artistic content.

7. The method according to claim 1, wherein the system may accept and record more than one user having different IP addresses.

8. The method according to claim 1, wherein the users are at least one of an agent and public user.

9. The method according to claim 8, wherein a ranking score from the agent is given greater weight than a ranking score from the public user.

10. The method according to claim 8, wherein a ranking score from an initial public user is given greater weight than a subsequent same public user.

11. A system for ranking an artistic content submitted by an auditionee, the system comprising:
a talent broker management system for serving as the broker between an user and the auditionee, the talent broker management system having a server and a computer-readable storage,
wherein the talent broker management system is configured to execute the instructions of:
retrieving the artistic content stored in a talent broker management system by a user;
reviewing the submitted artistic content;
rating the artistic content based on a ranking score;
recording an IP address of the user; and
determining whether the user is a duplicate user that rates the same submitted artistic content.

12. The system according to claim 11, wherein the system determines whether the user is a duplicate, if so, the system reduces the ranking score of the duplicate user.

13. The system according to claim 11, wherein the system determines whether the user is a duplicate, if so, the system rejects the ranking score of the duplicate user.

14. The system according to claim 11, wherein a ranking score from an agent is given greater weight than a ranking score from a public user.

15. The method according to claim 14, wherein a ranking score from an initial public user is given greater weight than a subsequent same public user.

16. The system according to claim 11, further comprising a bidding structure to allow auditionees to bid for a time slot.

17. A method for bidding on a time slot for an artistic content submitted by an auditionee, comprising:
selecting a particular time slot for the artistic content to be reviewed; and
bidding on the particular time slot by setting an amount for the selected time slot.

18. The method according to claim 17, wherein the auditionee places a higher bid if the submitted bid is lower than a next lowest bid as long as the time to place the bid has not expired.

19. The method according to claim 17, wherein the auditionee sets a maximum bid amount.

20. The method according to claim 17, wherein the highest maximum bid amount at the close of bidding is guaranteed to display the video at the winning time slot.
